(19) United States
(12) Patent Application Publication
(10) Pub. No.: US 2021/0019139 A1
(43) Pub. Date: Jan. 21, 2021

(54) BLOCKING AND UNBLOCKING MECHANISM FOR SOFTWARE UPDATES FOR A CONTROLLER

(71) Applicant: Robert Bosch GmbH, Stuttgart (DE)

(72) Inventors: Johannes Rehagen, Karlsruhe (DE); Mario Neubauer, Iffezheim (DE); Michael Soellner, Lichtenau (DE); Patric Kahles, Buehl (DE)

(21) Appl. No.: 17/043,241

(22) PCT Filed: Mar. 6, 2019
(86) PCT No.: PCT/EP2019/055492

§ 371 Date: Sep. 29, 2020

(30) Foreign Application Priority Data
Mar. 29, 2018 (DE) 10 2018 204 934.3
Feb. 28, 2019 (DE) 10 2019 202 681.8

(51) Int. Cl. G06F 8/65; G06F 8/41; H04L 12/40; B60H 1/00

(52) U.S. Cl. CPC G06F 8/65; G06F 8/433; H04L 12/40; H04L 2012/40241; H04L 2012/40273; H04L 2012/40215; B60H 1/00421

(57) ABSTRACT

The invention relates to a controller (1) for controlling a component (10) of a motor vehicle, in particular an electric motor, a valve, a pump, a fan drive, in particular for HVAC applications or for drive system temperature control, having a processor (30), preferably a microcontroller (40), and an interface (20) that is designed such that a software update is able to be received, in particular applied, by way of the interface (20). It is proposed for the controller (1) to have a blocking mechanism that, when it is activated, prevents the software update from being applied, wherein the blocking mechanism is able to be activated in a time-controlled, event-controlled and/or signal-controlled manner.

### BACKGROUND OF THE INVENTION

The invention relates to a control device for controlling a component of a motor vehicle and to a method for operating a control device which controls a component of a motor vehicle.

Control devices in the motor vehicle sector are nowadays customarily designed to be programmable. The known control devices have a control device software which can be updated or changed, in particular by means of software updates. The software can be updated by way of specific interfaces of the control device. The control devices are connected to the communication bus of the vehicle via the specific interfaces. In order to load a software update onto the control device, the use of workshop equipment specifically designed for this purpose is customarily necessary. Also known are alternative methods and devices which allow updating of the software by means of direct connection to the control device, for example via the supply plug, a programming plug, by opening the control device or direct contacting.

It is known to date to limit loading of software updates for example by means of a password or a security check.

### SUMMARY OF THE INVENTION

It is particularly advantageous that a control device is provided for controlling a component of a motor vehicle, in particular an electric motor, a valve, a pump, a fan drive, in particular for HVAC applications or for drive system temperature control. The terms “control” and “controlling” are to be understood below as always including “regulation” and “regulating” in the respective sense of open-loop and closed-loop control. The same equally applies to a control device, which also encompasses a regulating device. “Software” is also understood to mean the control device software or firmware. Correspondingly, a “software update” is understood to mean a control device software update or a firmware update.

The control device has a processor, in particular a microprocessor, and/or a microcontroller. The microcontroller comprises the processor, in particular the microprocessor. Furthermore, the control device has an interface which is designed in such a way that a software update for the control device can be received, in particular applied, by means of the interface. Furthermore, the interface is designed to receive and/or transmit signals, in particular commands or information.

It is advantageous for the control device to have a blocking mechanism. After its activation, the blocking mechanism inhibits, in particular prevents, the application of a software update. After the activation of the blocking mechanism, an application and a changing of the software and/or parameters, in particular settings, of the control device and in particular of the processor and/or of the microcontroller are not possible. The blocking mechanism can be able to be activated in a time-controlled, event-controlled and/or signal-controlled manner. The activation is preferably effected by the processor or the microcontroller.

It is advantageous for the processor and the microcontroller to undertake the checking of the operations which are important for the activation of the blocking mechanism. The microcontroller or processor checks whether one or more, in particular predefined, operations, one or more events and/or a combination have/has occurred and/or whether a defined time has elapsed and/or a signal has arrived. If one of the conditions has occurred in the predefined frequency or the predefined point in time, the blocking mechanism is activated. It is also conceivable for the activation to occur on the basis of a combination of operations and events. The activation can also occur if a defined time has elapsed after the occurrence of an event, with the time elapsing only under defined conditions.

One advantageous development is that the activation occurs by means of the interface. An activation by the interface itself is advantageous if a signal-dependent activation is desired. The interface can thus activate the blocking mechanism independently if it receives a desired number of a defined signal, in particular a data packet. Only a small processor power if any is necessary for this purpose. The interface evaluates in particular the incoming data packets. In particular, the activation can occur if the interface detects signals, in particular data packets, which are transmitted when the vehicle is driven for the first time, in particular by a customer.

One advantageous development is that the interface is designed and/or configured, with the blocking mechanism activated, to make possible, in particular to allow, a communication via the interface. In spite of the activation, the interface can continue to be used for communication with the control device. It is possible for example for control commands, internal data, traceability data, status information and/or device configurations to be transmitted, in particular transmitted to or received by the control device.

According to one advantageous development, firmware or software updates and/or parameter changes and/or changes of the settings are suppressed, in particular by the processor and/or the microprocessor. Preferably, after the activation of the blocking mechanism, only the application of a software update and/or the changing of parameters and/or settings are/is inhibited, with all further communication being possible. It is advantageous that no further interface is required for communication.

According to one advantageous development, the interface, the processor and/or the microprocessor deny/denies the acceptance of signals, in particular data packets, which contain firmware and/or software components which change the operating software. Also denied are data packets which change the settings and/or parameters. What is to be understood by “denying” is in particular the nonacceptance but also the refusal or direct deletion.

According to one development, the bootloader is deactivated when the blocking mechanism is activated. The bootloader is not executed. The nonexecution of the bootloader prevents software and/or firmware updates from being applied.

According to one development, the bootloader, with the blocking mechanism activated, refuses the implementation of a software update, of a firmware update or the changing of parameters.

According to one development, with the blocking mechanism activated, the writing to data storage devices, in particular in which parameters, settings and/or the software or firmware are/is stored, is inhibited. No changes in these storage devices can be carried out. The storage in persistent data memories is preferably inhibited, in particular not possible. A simple implementation is possible.

One advantageous development is that the interface is designed to connect the control device to the vehicle. The interface is preferably designed in such a way that it allows a connection to bus systems, used in the motor vehicle. Such bus systems are in particular CAN, LIN, Powertrain, x-by-wire, TTP/B, MOST, D2B and FlexRay bus systems. The control device can advantageously be integrated into the existing system architecture.

It can be considered to be an advantageous development for the blocking mechanism to be implemented by the interface. After activation of the blocking mechanism, an application of a software update to the control device is inhibited, in particular prevented.

One particularly advantageous development is that the blocking mechanism is realized by the processor, in particular the microcontroller itself. The blocking mechanism is directly implemented in the processor or the microcontroller. The processor or the microprocessor inhibits the acceptance and the application of a software update. In particular, the interface, the processor and/or the microprocessor do/does accept the software update data packets but rejects them. A situation can be prevented in which, in spite of the blocking mechanism being activated, the software update is applied to the microcontroller or the processor. In particular subsequently applied software updates can thus be prevented.

One advantageous development is that the blocking mechanism is implemented on the part of the software. The control device is designed and/or configured in such a way that it can analyze and evaluate the incoming data packets.

One advantageous development is that a housing is provided. The processor, the microcontroller and/or the interface are arranged within the housing. The blocking mechanism is preferably formed by at least one additional electrical component. A situation can advantageously be prevented in which an update can be applied by means of manipulation. A situation can also be prevented in which the activation of the blocking mechanism can be canceled by means of manipulation.

One advantageous development is that the interface is designed to receive and transmit signals on the vehicle bus by means of the interface. The processor and/or the microcontroller are/is designed to evaluate the signals and to activate the blocking mechanism in dependence on defined events and/or received signals and/or a combination thereof. The detection and monitoring of the vehicle signals preferably occurs in order to activate the blocking mechanism. Conditions can be defined which are dependent for example on other vehicle data or operating information. The activation of the blocking mechanism is preferably dependent on the number of received signals and/or occurred events or a predefined time since the occurrence of an event and/or the receipt of a signal.

One advantageous development is that the control device is designed to activate the blocking mechanism during or after the production of the control device and/or during or after the vehicle production and/or during the first use of the vehicle by the end customer. In particular, the blocking mechanism can be activated after a defined temporal use, in particular x hours. There preferably results here the possibility that the application of software updates is still possible up to a desired point in time. In particular, it is thus for example still possible to apply software updates up to the completion of the control device or of the vehicle. It is only with the occurrence of one of the conditions that the application of software updates is prevented, in particular inhibited.

The invention further relates to a method for operating a control device which is designed to control a component of a motor vehicle. The method comprises the following steps:
detecting whether the control device is already blocked by means of the activated blocking mechanism,
activating the blocking mechanism of the control device, which inhibits the application of updates, if it is determined that a number or a predefined number of events have occurred, a predefined time has passed and/or a predefined number of predefined signals have been received.

One advantageous development of the method is that the blocking mechanism is activated if one or more conditions are satisfied. Here, the conditions can be the receipt of one or more signals, in particular of a command or of an item of information, the occurrence of one of more events, in particular the use of the vehicle by the end customer and/or the expiry of a defined time. The activation preferably occurs as a reaction to a combination of occurred operations.

One advantageous development is that, after the activation of the blocking mechanism, the interface can continue to be used for communication, in particular for receiving or transmitting control commands, internal data, traceability data, status information and/or device configurations. No further interface is required for communication.

The method advantageously comprises detecting whether the motor vehicle is used, in particular by evaluating the signal which is received by the interface.

According to one development of the method, software updates comprise parameter changes and setting changes.

One advantageous development is distinguished by the fact that the method is run through for each signal received at the interface, and that the run-through of the method is ended in particular when the blocking mechanism is activated, and that the signals are preferably evaluated. Consequently, the whole method does not have to be run through to activate the blocking mechanism. According to one development, the method is no longer run through if the blocking mechanism is activated.

One advantageous development is that an activated blocking mechanism cannot be deactivated. The inhibited software updateability cannot be restored.

### BRIEF DESCRIPTION OF THE DRAWINGS

The invention is described in more detail below. In the figures:

FIG. 1 shows a control device according to the invention, and

FIG. 2 shows a flow diagram with the method according to the invention.

### DETAILED DESCRIPTION

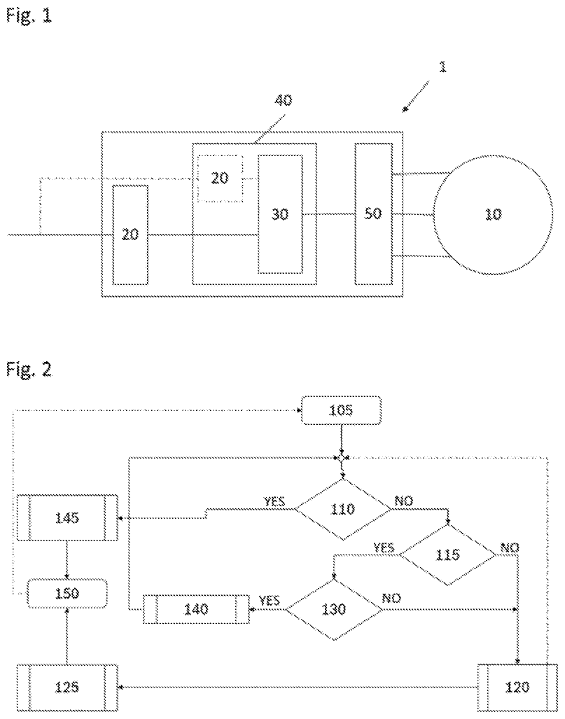

FIG. 1 illustrates a control device 1 according to the invention. The control device 1 is designed to control or regulate a component of a motor vehicle. A component 10 of a motor vehicle can be understood to mean in particular an electric motor, a pump, a valve, a fan motor, in particular for HVAC applications and/or for drive system temperature control. The components mentioned here are preferably supply units or miniature drives which are provided to supply, in particular to assist, the operation of the drive motor, of the inverter and/or of the battery in an electrically driven vehicle. It is also possible for such miniature drives or supply units to be used in vehicles having an internal combustion engine or another drive, for example a hydrogen-based drive system. The components 10 can also be part of the HVAC system of the vehicle or be used for cooling or heating further motor vehicle components, in particular components of the drive.

According to one development, what is concerned here is the vehicle drive itself, or individual components of the vehicle drive.

According to one development of the invention, the components 10 are electrically commutated electric motors. These electrically commutated electric motors can also be used as a drive for pumps, valves, fans and/or compressors. The electrically commutated electric motor has in particular at least three motor phases. The motor phases are traversed by a flow of current in such a way as to produce a rotating electrical field which is entrained by the magnets of the rotor. The rotating electrical field brings about a rotational movement of the rotor.

The activation of the electrically commutated electric motor, that is to say of the electrically commutated component 10, is effected by means of an output stage. The output stage has electronic switches which in particular have a B6 arrangement. The electronic switches are preferably designed as power transistors or MOSFETs. The electronic switches are activated by a control signal. The current which flows through the three phases and hence through windings of the electric motor is regulated in dependence on the control signal. The control signals are provided by the control device 1.

The control device 1 comprises an interface 20 and a processor 30, in particular a microprocessor. The interface 20 is designed in such a way that, being connected to the communication network of the motor vehicle, it allows communication via the latter. Communication networks in the motor vehicle sector are in particular bus systems, preferably CAN, LIN, Powertrain, x-by-wire, TTP/B, MOST, D2B or FlexRay bus systems. The interface 20 allows commands to be received and transmitted. Furthermore, the interface 20 is designed to receive software updates. According to the invention, the interface can also communicate wirelessly, in particular by means of Bluetooth, Wifi, Zigbee, radio and/or Z-Wave.

The processor 30, in particular the microprocessor, is a programmable computing unit consisting of electrical circuits. A processor is also understood below to mean a microprocessor or the like. The processor 30 is designed in such a way that it controls other machines or electrical circuits in dependence on commands and thereby executes an algorithm. The commands are received by the processor 30 via the interface 20. The interface 20 and the processor 30 are connected in such a way that communication from the interface to the processor 30, and vice versa, is possible. The interface 20 is preferably part of the processor 30.

According to one development of the invention, the control device 1 has a microcontroller 40. The microcontroller 40 is a semiconductor chip which contains the processor 30 and at the same time also peripheral functions. The main memory and programming memory are preferably also situated partially or completely on one and the same chip. The microcontroller can also comprise complex peripheral functions, such as for example the interface 20.

According to one development of the invention, the output stage 50 can be a peripheral function of the microcontroller 40. The microcontroller 40 comprises in particular the output stage 50.

The control device 1 is designed to carry out software updates. The software updates are applied in particular via the interface 20 to the control device 1 or to the microcontroller and/or processor. The software updates preferably change and/or update the software of the processor 30 and/or of the microcontroller 40. The software update can for example bring about a change in the activating behavior of the component. The software updates are preferably applied via the interface to a memory which interacts with the processor and/or the microcontroller. The software updates are applied in particular by means of a bootloader.

The bootloader carries out the software update by overwriting the previous data memory locations of the software with the new software. The software update is in particular installed.

What is to be understood by software is the firmware or the operating software which is required to operate the processor or the component.

The control device 1 has a blocking mechanism which allows it, after activation, to inhibit the application of software updates. If the blocking mechanism is activated, the software of the control device 1 cannot be updated or changed. Defined parameters and/or variables can preferably no longer be changed. In particular, a changing of nonvolatile or persistent memories is prevented. The control device is designed, after activation, to inhibit the changing of defined parameters and/or variables. The control device 1, in particular the interface, prevents the application of a software update after the activation of the blocking mechanism. Here, a software update is understood to also always mean a firmware update. Nevertheless, in spite of the blocking mechanism being activated, the interface can continue to be used for communication and thus to exchange data.

According to a first embodiment, the blocking mechanism is part of the interface 20. The interface 20 thus comprises the blocking mechanism. If the blocking mechanism is activated, the interface 20 prevents the software update from being forwarded to the processor 30 or the microprocessor 40, or the data memory in which the software is stored.

According to a second embodiment, the blocking mechanism is part of the processor 30 and/or of the microcontroller 40. If the blocking mechanism is activated, the processor 30 and/or the microcontroller 40 prevent/prevents the application of a software update. The execution or the starting of a software update is preferably prevented.

Furthermore, the bootloader, which allows the software update, in particular carries it out, is prevented from being executed. When the blocking mechanism is activated, the system no longer starts the bootloader.

A changing of the software of the control device 1 is inhibited or prevented after activation of the blocking mechanism. Also prevented is the possibility of applying supplements of the software, for example new modules which allow the function range to be extended, or the like.

The microcontroller 40 and the processor 30 are designed to communicate with further components 10 of the motor vehicle via the interface 20. The microcontroller 40 and the processor 30 can receive and/or transmit signals, in particular information signals and/or command signals, via the interface 20. Internal data can also be read by the control device, such as voltages, consumption, test results and/or measuring times. There can also be read traceability data, such as in particular production data, information about factory, line, date, timestamp, production steps, TTNR, device configuration, status, point in time of the activation of the blocking mechanism. The processor 30 and/or microcontroller 40 are/is designed to evaluate and process the received signals and correspondingly activate the component.

The blocking mechanism is activated in particular in a time-dependent manner, in dependence on defined events, received signals or a combination thereof.

A time-dependent activation of the blocking mechanism can occur for example after a defined time. Such a time can be for example the operating time of the motor vehicle. In particular, the activation can occur in particular after X hours' operating time. The activation is prevented from already occurring during the production.

An activation of the blocking mechanism can occur in dependence on a signal, for example if a specific signal is detected at the connected vehicle bus, and/or if a combination of signals is detected at the control device 1 and/or if a signal is detected which signals that the vehicle has ended the production phase and/or if it is detected by means of a signal that the component has been put into operation for the first time and/or that the production process for the component has been successively concluded and/or if it is detected that the vehicle has exceeded a certain speed.

Furthermore, the activation of the blocking mechanism can occur in dependence on the number and/or type of the detected bus signals, in particular data packets. For this purpose, the control device 1 for example counts the number of bus signals, in particular the number of specific bus signals, which it receives via the interface 20. If a predefined value is exceeded, the blocking mechanism is activated.

The activation preferably occurs at the end of production, in particular before the delivery to the OEM, the TIER company or the end customer.

The detection of events can also be used to activate the blocking mechanism.

For example, the activation of the blocking mechanism occurs after the component has been in operation in the motor vehicle for a defined minimum time. The vehicle bus signals are evaluated at the interface 20 of the control device 1. For as long as the vehicle bus signals are detected, a timer in the control device 1 is incremented. After a limit value has been reached, the blocking mechanism is activated. If for example other signals are used during the production by the component manufacturer or by the vehicle manufacturer, the timer is not incremented. For the manufacturer of the component, it is possible to apply software updates as often as desired up to the activation of the blocking mechanism. Furthermore, the vehicle manufacturer, in particular during the production, can apply software updates as often as desired.

As a development, a combination of the aforementioned detected signals, events and/or operating times can be used to activate the blocking mechanism. In particular, there can also occur an activation of different criteria and/or operations which by means of or are linked with one another. For example, an activation can occur if a certain number of bus signals have been received by the interface 20. At the same time, an activation can also occur if the motor vehicle exceeds a certain speed for the first time. Depending on which of the conditions occurs first, the activation occurs on the basis of the occurrence of these conditions.

According to one development of the invention, the activation of the blocking mechanism can occur in dependence on the number of the software updates carried out. A situation would thus be possible in particular in which for example the component manufacturer can apply one or more software updates and the car manufacturer can likewise apply one or more software updates.

According to one development of the invention, the control device 1 has a housing. The processor 30 and the microcontroller 40 are arranged within the housing. The housing is filled with a potting compound. The potting compound cures after being poured in. The potting compound has the effect that contacting, in particular direct contacting with the pins of the processor 30 or of the microcontroller 40, is then only possible if the potting compound is removed and thus damaged.

FIG. 2 illustrates the method 100 according to the invention. The method is started in method step 105. Such a start occurs for example during the starting of the engine or shortly before the driver of the motor vehicle drives away. It occurs if a new signal, in particular a data packet, arrives at the interface. However, the method is also carried out during test runs in the production. In general, the method can always be carried out when the motor vehicle is used.

In method step 110, it is checked whether the blocking mechanism is already activated or has been activated. If the blocking mechanism is not activated, the procedure continues with method step 115. If the blocking mechanism is activated, the procedure continues with method step 145, which will be described below.

In method step 115, it is checked whether one or more defined conditions have occurred. Such a condition can be an event, for example. The event can preferably be for example the use of the motor vehicle. The conditions also comprise the aforementioned conditions. If the event has not occurred, the procedure continues with method step 120. In method step 120, the application of a software update is possible. Subsequent to method step 120, the control device 1 switches into the extended operation mode 125. If the control device is in the extended operation mode/method step 125, the application of a software update is possible. The extended operation mode 125 corresponds to the standard use mode 150 only the a application of software updates and/or parameters is possible, since the blocking mechanism is deactivated.

Optionally, subsequent to the method step, the method can switch back into method step 105.

According to one development of the invention, the method step 105 is left only if it is attempted to apply a software update. In method step 105, it is checked whether an attempt is made to apply a software update.

If the conditions are satisfied in method step 115, further conditions can be interrogated in an optional method step 130. However, it is also possible to switch directly to method step 140.

In method step 140, the blocking mechanism is activated. If the optional further conditions are not satisfied in the optional method step 130, the procedure is continued with method step 120.

If the checking in method step 110 reveals that the blocking mechanism is already activated, the system passes into the standard use mode 145. In the standard use mode 145, the application of software updates is inhibited. The blocking mechanism is activated. Nevertheless, communication can continue via the interface. In particular, a writing to the memory in which parameters and the software are stored is inhibited. The bootloader is preferably prevented from being executed.

According to one development of the invention, the method 100 is carried out for each incoming signal, in particular data packet. If the blocking mechanism is activated, the data packet, which contains software or parameters, in particular also a command for changing a parameter, is rejected or refused.

If the blocking mechanism is activated, there is no writing to and/or overwriting of the software or firmware memory of the processor, in particular microcontroller, such that the software, in particular of the control device, is overwritten. The software update is inhibited.

It is preferably no longer possible to write to or overwrite the persistent memory of the microcontroller or processor.

Optionally, it is possible in method step 120 also for method step 110 to follow. As a result, there occurs a continuous interrogation of the conditions in method step 115 and the optional method step 130.

In the optional method step 150, a signal, in particular a packet, is awaited. If a signal is received, method step 105 is carried out. This occurs in particular when the method is carried out for each incoming data packet.

According to one development, the blocking mechanism is not activated if a software update is being carried out.

What is concerned according to the invention is a method 100 for activating a blocking mechanism which inhibits updates, in particular software updates, being applied to a control device for controlling components of a motor vehicle. An update of the software is also understood to mean a changing of the software by means of a software update. Furthermore, this can also be understood to include a software change, in particular a software downgrade. In particular, the control software and/or firmware is to be understood here under software.

What is also concerned according to the invention is a method 100 for blocking the possibility of changing, in particular updating and/or downgrading, a control device 1 which is designed to control a component of a vehicle.

According to one embodiment, the blocking mechanism is designed as a software switch. In particular, a variable and/or a parameter are/is set and/or a function is started. According to one development, the blocking mechanism is configured as a type of firewall which blocks or does not forward the corresponding data packets. The blocking mechanism is advantageously designed as part of the interface.

According to a second embodiment, the blocking mechanism is configured as a hardware switch. This can be implemented in particular by throwing a switch and/or switching an electrical switch, such as for example a transistor or MOSFET. However, it can also be implemented by the blowing of a fuse or the melting of a component. An electrical energy accumulator, in particular a capacitor, can also be charged or discharged. The hardware switch can here be part of the control device 1. The hardware switch can also be implemented in the interface 20 or the processor 30 or the microcontroller 40. In particular, a flag is set by means of the hardware switch that has the effect of inhibiting software-changing measures. The flag is checked in particular in method step 110. Once set, the flag can no longer be changed.

A memory location is preferably changed. The memory location is part of a nonvolatile memory, in particular of a permanent, preferably a persistent, memory which once changed can no longer be changed. The memory is part of the control device 1, in particular of the microcontroller 40, preferably of the processor 30. The memory can also be part of the interface 20. The memory location is checked in method step 110.

1. A control device (1) for controlling a component (10) of a motor vehicle, the control device (1) having a processor (30) and an interface (20) configured to receive a software update, wherein the control device (1) has a blocking mechanism which, upon activation, inhibits the application of the software update, wherein the blocking mechanism can be activated in a time-controlled, event-controlled and/or signal-controlled manner.

2. The control device (1) as claimed in claim 1, wherein the interface (20) is configured to allow a communication with the blocking mechanism activated, with internal data, traceability data, status information and/or device configurations continuing to be received or transmitted.

3. The control device (1) as claimed in claim 1, wherein the interface (20) is configured to connect the control device (1) to the motor vehicle, via a bus system.

4. The control device (1) as claimed in claim 1, wherein the blocking mechanism is implemented by the interface (20).

5. The control device (1) as claimed in claim 1, wherein the blocking mechanism is implemented the processor (30).

6. The control device (1) as claimed in claim 1, further comprising a housing, and wherein the processor (30) is arranged within the housing, wherein the housing is filled with a curing potting compound in such a way that contacting of the processors (30) is possible only after at least partial removal of the potting compound.

7. The control device (1) as claimed in claim 1, wherein the interface (20) is configured to receive signals on a vehicle bus connected to it, wherein the interface and/or the processor (30) is/are configured to evaluate the signals and to activate the blocking mechanism in dependence on defined events, received signals, and/or a combination thereof.

8. The control device (1) as claimed in clam 1, wherein the control device (1) is configured to activate the blocking mechanism during or after the production of the control device (1) and/or during or after the motor vehicle production and/or during the first use of the motor vehicle by the end customer.

9. A method (100) for operating a control device (1) which is designed to control a component (10) of a motor vehicle, the method comprising the following steps:
detecting (110) whether the blocking mechanism of the control device, which inhibits the application of software updates, is activated,
activating (140) the blocking mechanism of the control device (1) if a determination (115, 130) reveals that a number or a defined number of events have occurred, a defined time has passed and/or a number or a defined number of signals have been received.

10. The method (100) as claimed in claim 9, further comprising the following step:
activating (140) the blocking mechanism when it is detected that the motor vehicle is used by evaluating signals received by the interface (20).

11. The method (100) as claimed in claim 9, wherein, after the activating (140) the blocking mechanism, the interface continues to be used for receiving or transmitting control commands, internal data, traceability data, status information and/or device configurations.

12. The method (100) as claimed in claim 9, wherein the method is run through for each signal received at the interface (20), and in that the run-through of the method (100) is ended when the blocking mechanism is activated.

13. The method (100) as claimed in claim 9, further comprising inhibiting the application of software updates with the blocking mechanism activated.

14. (canceled)
